(19) United States
(12) Patent Application Publication
(10) Pub. No.: US 2004/0037161 A1
(43) Pub. Date: Feb. 26, 2004

(54) Emulsifying method and apparatus

(75) Inventors: Nobuaki Honda, Tokyo (JP); Kazuhiro Mae, Kyoto-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Yamatake Corporation, Shibuya-ku (JP)

(21) Appl. No.: 10/644,517

(22) Filed: Aug. 19, 2003

(30) Foreign Application Priority Data
Aug. 23, 2002 (JP) 2002-243215

(51) Int. Cl. B01F 5/06

(52) U.S. Cl. 366/176.1; 366/336

(57) ABSTRACT

An emulsifying apparatus includes a multistage channel provided between plural inlets and a single outlet and having plural channel stages. A sectional area of the individual channel stage is larger than that of the immediately downstream channel stage on the outlet side, so that shearing rate of fluids flowing in the multistage channel gradually increases toward the outlet side to promote fluid dispersion, whereby a high-quality emulsion having an uniform particle diameter is produced with excellent mass producibility.

### BACKGROUND OF THE INVENTION

1. Technical Field

The present invention relates to an emulsifying method and apparatus, and more particularly, to an emulsifying method and apparatus that are suitable for mass production of a high-quality emulsion.

2. Related Art

An emulsion (mixture) of immiscible fluids such as water and oil is produced for example by forcibly inserting a dispersed phase (oil) into a continuous phase (water) using straight-through microchannels (minute fluid passages), as proposed in Paper No. C216 entitled “Emulsion Production Using Straight-through Rectangular Microchannels Having Different Aspect Ratios and Sizes,” the 67th Annual Conference of Society of Chemical Engineering in Japan. However, this proposed technique requires surface-active agent for emulsion preparation. In addition, microchannels having a narrow width of about 10 μm are easily clogged with dispersed phase particles and can cause a pressure loss, resulting in poor mass producibility of emulsion.

Also known is a micromixer available from IMM Mainz (Institut Fur Mikrotechnik Mainz GmbH), which can produce emulsions without using surface-active agent but is comprised of microchannels of about 25-40 μm in width formed by means of a fine processing technology that is known as LIGA (German acronym for Lithographe, Galvanaformung and Abformung) process. This micromixer whose channel width is considerably narrow still entails the problem of microchannels being easily clogged and a relatively high pressure loss being generated, so that the mass producibility of emulsion is not high enough. In addition, the micromixer can cause a substantial problem that an allowable range of fluid mixing ratio in the emulsion production is excessively narrow, making it difficult to produce emulsion of equal parts of water and oil.

As explained above, a conventional emulsifying method and apparatus have several drawbacks in industrial use. That is, easily cloggable microchannels can lower the mass producibility of emulsion, a relatively narrow allowable range of fluid mixing ratio makes it difficult to produce emulsion at a desired fluid mixing ratio, especially, emulsion of equal parts of fluids, and microchannels of about 10-40 μm width to be formed by a fine processing technology result in high fabrication costs.

### SUMMARY OF THE INVENTION

An object of the present invention is to provide an emulsifying method and apparatus that are suitable for producing a high-quality emulsion at a desired fluid mixing ratio with excellent mass producibility, without using surface-active agent and without causing microchannels to be clogged.

According to one aspect of the present invention, there is provided an emulsifying method in which plural kinds of fluids are introduced into and mixed in a multistage channel to produce an emulsion. The emulsifying method causes shear stress to generate in the fluids during the fluid mixing in the multistage channel, thereby generating electric charges in the fluids due to the shear stress, while increasing interfacial areas between the fluids.

The emulsifying method of this invention generates electric charges in fluids, while increasing interfacial areas between the fluids, so that electric charges satisfactorily accumulate on the fluids, thereby achieving an appropriate fluid dispersion. As a result, this method can produce a high-quality emulsion having a uniform particle size with excellent mass producibility, without using surface-active agent. The excellent fluid dispersion can achieve a satisfactory fluid mixing at a desired mixing ratio. In particular, this method is suitable for mixing equal parts of immiscible fluids such as oil and water. According to the present invention that permits the channel to have a relatively wide width, channel clogging and pressure loss can be prevented.

Preferably, a degree of increase in interfacial areas between the fluids and a degree of electric charge generation gradually increase from an upstream side toward a downstream side of the multistage channel. For instance, by gradually increasing flow velocities of the fluids toward the downstream side of the multistage channel, both the degree of increase in interfacial areas and the degree of electric charge generation increase toward the downstream side of the channel. This preferred embodiment can efficiently mix the fluids, while promoting the fluid dispersion, as the fluids flow through the multistage channel. Therefore, this embodiment is suitable for the mass production of a high-quality emulsion at a desired fluid mixing ratio.

Preferably, the fluid mixing in the multistage channel is performed by dividing a fluid, joining fluids into one, converting a fluid flow, and by inertia-force-based mixing. This preferred embodiment can attain a satisfactory fluid dispersion, making it possible to carry out the mass production of a high-quality emulsion at a desired fluid mixing ratio.

According to another aspect of this invention, there is provided an emulsifying apparatus which comprises plural inlets, a single outlet, and a multistage channel provided between the plural inlets and the single outlet. The multistage channel is comprised of a plurality of channel stages each constituted by one or more channels, and has a fluid passage sectional area gradually decreasing from a inlet side toward an outlet side of the emulsifying apparatus.

In the emulsifying apparatus of this invention having the multistage channel whose sectional area decreases toward the outlet side, fluid flow velocities gradually increase as the fluids flow from the inlet side to the outlet side. Thus, the shearing rate (shear stress) of the fluids attributable mainly to contact between the fluids and channel wall surfaces increases toward the outlet side, and electric charges generate in the fluids due to shear stress, resulting in a satisfactory fluid dispersion. This makes it possible to realize an efficient mass production of high-quality emulsion at a desired fluid mixing ratio without using surface-active agent and without causing channel clogging and pressure loss.

Preferably, the multistage channel includes at least one division section for dividing a fluid, at least one confluence section for joining fluids into one, and at least one diversion section for diverting a fluid flow that are arranged in a predetermined order from the inlet side to the outlet side. According to this preferred embodiment, fluids are mixed satisfactorily while fluid dispersion is promoted, as the fluids flow downstream toward the outlet side.

Preferably, the multistage channel is comprised of one or more channels each having a representative length varying from 100 μm to 500 μm. This preferred embodiment capable of having a relatively large representative length that specifies the channel width, channel depth or the like can prevent channels from being clogged with dispersed phase (oil) particles and can prevent occurrences of a pressure loss.

Preferably, the multistage channel is comprised of a series of grooves formed in a joining surface of plates. With this preferred embodiment, the multistage channel has a simplified construction to improve the mass producibility of the multistage channel and the emulsifying apparatus.

### BRIEF DESCRIPTION OF THE DRAWINGS

FIG. 1 is a schematic view showing a basic structure of a micro emulsator according to the present invention;

FIG. 2 is a view showing by way of example a microchannel constituted by a static mixer;

FIG. 3 is a view showing two channel stages each constituted by two-dimensionally arranged microchannels;

FIG. 4 is a view showing two channel stages each constituted by two-dimensionally arranged slit-like microchannels;

FIG. 5A is a microphotograph of an emulsion prepared by using the micro emulsator according to this invention;

FIG. 5B is a microphotograph of another emulsion prepared by using the micro emulsator of this invention;

FIG. 5C is a microphotograph of an emulsion prepared by using a micromixer of IMM Mainz;

FIG. 6 is a graph showing droplet diameter distributions in the aforementioned emulsions;

FIG. 7 is an exploded perspective view of a micro emulsator according to an embodiment of this invention;

FIG. 8A is a schematic plan view of a lower plate of the micro emulsator shown in FIG. 7;

FIG. 8B is a schematic plan view of a fluid passage module of the emulsator shown in FIG. 7;

FIG. 9 is a fragmentary schematic perspective view showing a mixing/distributing unit provided in a module;

FIG. 10 is a view for explaining a fluid mixing/distributing function of units provided in modules;

FIG. 11A is a view showing a modification of the mixing/distributing unit;

FIG. 11B is a view showing another modification of the mixing/distributing unit;

FIG. 11C is a view showing a further modification of the mixing/distributing unit;

FIG. 12 is a schematic perspective view showing a micro emulsator according to another embodiment of this invention;

FIG. 13 is a sectional view taken along line XIII-XIII in FIG. 12;

FIG. 14 is a sectional view taken along line XIV-XIV in FIG. 12; and

FIG. 15 is a view showing a multistage microchannel for the emulsator shown in FIG. 12.

### DETAILED DESCRIPTION

With reference to the accompanied drawings, an emulsifying apparatus for embodying an emulsifying method of this invention will be explained.

The emulsifying apparatus of this invention comprises a plurality of inlets (fluid introducing ports), a single outlet (fluid discharging port), and a multistage channel provided between the inlets and the outlet. Preferably, the emulsifying apparatus is configured in the form of a micro emulsator having a multistage microchannel that is constituted by one or more microchannels (minute fluid passages). The multistage microchannel can be constituted variously as described below.

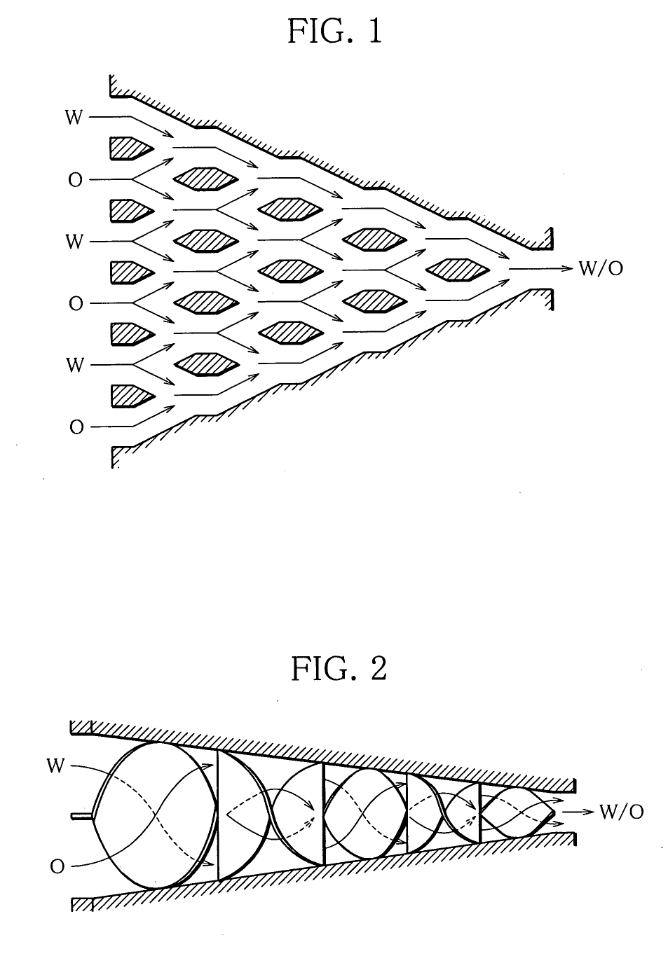

In the example shown in FIG. 1, the multistage microchannel includes an upstream-most channel stage comprised of six microchannels individually connected to six inlets of the emulsifying apparatus, a downstream-most channel stage comprised of a single microchannel connected to the outlet of the emulsifying apparatus, and four intermediate channel stages interposed between the upstream-most and downstream-most channel stages. Hence, six channel stages in total are provided in the multistage microchannel. The number of microchannels constituting each of the four intermediate channel stages decreases from 5 to 2 one by one, as the position of the intermediate channel stage in the multistage channel gets closer to the outlet.

The respective channels of the multistage microchannel are substantially the same in shape and sectional area from one another. The total channel sectional area (effective fluid passage sectional area) of the individual channel stage equals to the product of the number of channels of the channel stage and the sectional area of each individual channel. Thus, the individual channel stage has a narrower total channel sectional area as its position in the multistage channel gets closer to the outlet. In other words, the multistage microchannel has a sectional area that becomes gradually narrower from the inlet side toward the outlet side. Adjacent microchannels of each individual channel stage have their exits communicating with an entry of a corresponding microchannel of the next channel stage.

In the micro emulsator provided with the multistage microchannel having the above configuration, fluids supplied via the inlets to the multistage microchannel are gradually joined to and satisfactorily mixed with one another, while flowing through the multistage microchannel to the outlet.

Next, in the example shown in FIG. 2, the micro emulsator is provided with a so-called static mixer having a plurality of microchannels which are connected in series with one another and each of which constitutes a channel stage. In appearance, these microchannels form as a whole a single microchannel tapered in diameter (sectional area). The upstream-most channel has an entry connected to, e.g., two inlets, and has an exit connected to an entry of the immediately downstream channel. The downstream-most channel has an entry connected to an exit of the immediately upstream channel, and has an exit connected to the outlet. In each microchannel, a left element including a partition wall twisted at 180 degrees counterclockwise as viewed from upstream or a right element including a partition wall twisted at 180 degrees clockwise. Left elements and right elements are alternately disposed. When fluids pass through the individual element of the static mixer, they are divided into two by the partition wall, and the direction of fluid flow is diverted from radially inward to radially outward or from outward to inward by the twisted faces of the partition wall. When the fluids are about to flow into the next element, the rotational direction of fluid flow is reversed from the left to the right or from the right to the left, so that the direction of inertia force applied to the fluids is also reversed, whereby fluid mixing is promoted. Thus, each element serves as a division section for dividing a fluid, a diversion section for diverting a fluid flow, and a confluence section for joining fluids into one.

To be noted, the micro emulsator provided with the static mixer including the tapered microchannel (minute fluid passage) can proceed a fluid mixing by the mixer, while increasing the flow velocities (shearing rate) of the fluids on the outlet side of the emulsator.

Meanwhile, a micro emulsator may be realized by disposing a plurality of static mixers (microchannels) in array each of which is constructed as shown in FIG. 2.

As described above, in the emulsators of FIGS. 1 and 2, the multistage microchannel (minute fluid passage) has a sectional area decreasing from the inlet side to the outlet side, to thereby provide a fluid dispersion effect that becomes stronger toward the outlet side of the emulsator. In the multistage microchannel whose sectional area decreases toward the outlet side, flow velocities become gradually higher on the outlet side, so that fluid mixing is promoted while the interfacial areas between fluids are caused to increase and electric charges are generated in the fluids, where the electric charge generation is caused by shear stress that is generated attributable to contact between the fluids and channel walls. In this manner, the emulsators of FIGS. 1 and 2 are so configured that both the degree of increase in interfacial area and the degree of electric charge generation due to shear stress become gradually larger on the outlet side.

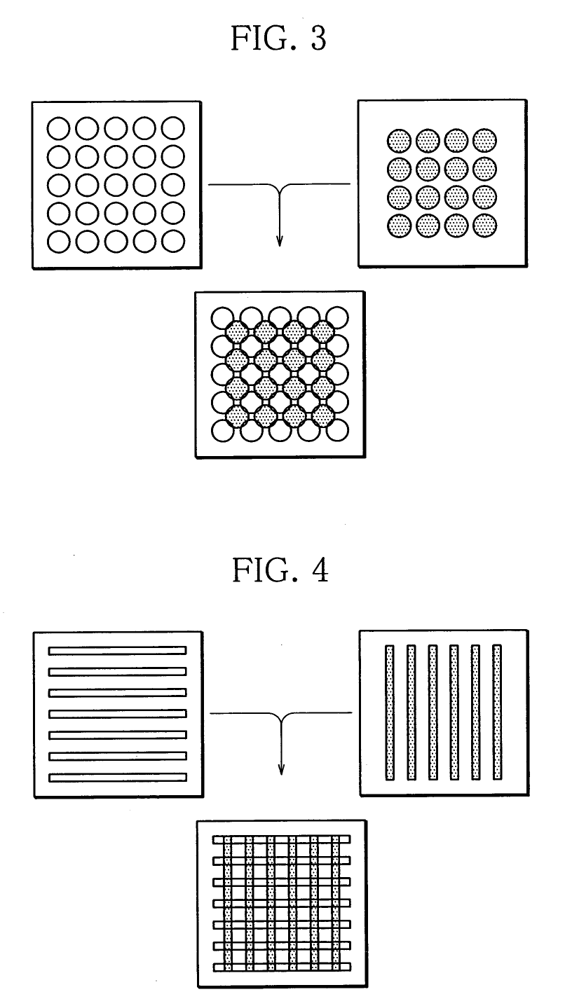

As shown in FIGS. 3 and 4, this invention is also applicable to a micro emulsator provided with a multistage microchannel having channel stages each comprised of a plurality of microchannels that are arranged two-dimensionally. Also in such an emulsator, the multistage microchannel is designed to have a sectional area gradually decreasing on the outlet side of the emulsator.

In the multistage microchannel exemplarily shown in FIG. 3, each individual channel stage is in the form of a fluid passage matrix comprised of a plurality of microchannels arranged in matrix and each having a circular cross section (only two fluid passage matrices are shown in FIG. 3). Rows and columns of the individual fluid passage matrix decrease in number one by one respectively, as the position of the matrix in the emulsator gets closer to the emulsator outlet. In FIG. 3, circular marks with dots denote microchannels constituting a downstream-side (upper) channel stage, whereas open circular marks denote microchannels constituting the immediately upstream-side (lower) channel stage. The upstream-side and downstream-side channel stages are in the forms of 5×5 matrix and 4×4 matrix, respectively. Each individual microchannel (i.e., fluid passage) of the downstream-side channel stage is connected to typically four fluid passages of the upstream-side channel stage. Thus, fluids from typically four directions are confluent into one fluid passage, and the fluid from that fluid passage branches typically four directions to enter corresponding fluid passages of the next channel stage.

In a multistage microchannel of a micro emulsator exemplarily shown in FIG. 4, each individual channel stage is constituted by a plurality of slit-like microchannels extending in parallel to one another, and the rows and columns of the individual channel stage decrease in number one by one respectively, as the position of the channel stage in the emulsator gets closer to the emulsator outlet (only two channel stages are shown in FIG. 4, and upstream-side and downstream-side channel stages are comprised of six channels and five channels, respectively). The microchannels of each channel stage extend perpendicularly to those of adjacent channel stages. In FIG. 4, open rectangular marks denote the microchannels (fluid passages) of the upstream-side (lower) channel stage, whereas rectangular marks with dots denote the microchannels of the downstream-side (lower) channel stage.

According to the micro emulsator of this invention comprising a multistage fluid passage whose sectional area gradually decreases toward the outlet side, the shearing rate between fluids and channel wall surfaces gradually increases, as the fluids flow from the inlet side to the outlet side of the emulsator. Thus, a fluid division function, a fluid flow diverting function, and a fluid mixing function achieved by the diverting function and inertia force are gradually strengthened, whereby fluid dispersion is promoted effectively and gradually. As the fluids flow downstream toward the outlet side, the inertia-force-based fluid dispersion effect gradually increases since the fluid flow velocity becomes gradually higher on the outlet side.

The above-mentioned functions strongly affect fluids of different kinds, especially, immiscible fluids (W/O) such as water (W) and oil (O). This makes it possible to effectively produce an emulsion (mixture) of immiscible fluids. Specifically, due to friction between the fluids, electric charges are generated and accumulate at interfacial surfaces between the fluids, to increase a zeta-potential that promotes fluid dispersion. Of course, an amount of accumulatable charge becomes larger with the increasing interfacial areas between the fluids.

To be noted, the zeta-potential becomes low to the extent that a sufficient fluid dispersion effect cannot be attained in a case where a sufficient electric charge is not generated for the reason that the interfacial areas of the fluids are large enough but the shear stress is low, or in a case where a sufficient charge is not accumulated for the reason that the shear stress is large enough to generate a sufficient charge but the interfacial areas of the fluids are small.

In this respect, according to the micro emulsator of this invention, the electric charge generation caused by shear stress and the increase in interfacial area with the progress of fluid dispersion take place in a well-balanced manner, and they are promoted as the fluid flow gets closer to the emulsator outlet. As a result, the electric charge generation and the fluid dispersion exhibit a synergistic effect without wastage, whereby an emulsion of a large zeta-potential in the order of, e.g., 75 mV, i.e., an emulsion of very satisfactorily dispersed fluids can be produced without using surface-active agent.

The present inventors fabricated a micro emulsator of this invention (hereinafter referred to as YM-1 or YM-1 emulsator), and produced emulsions by using YM-1 for performance evaluation.

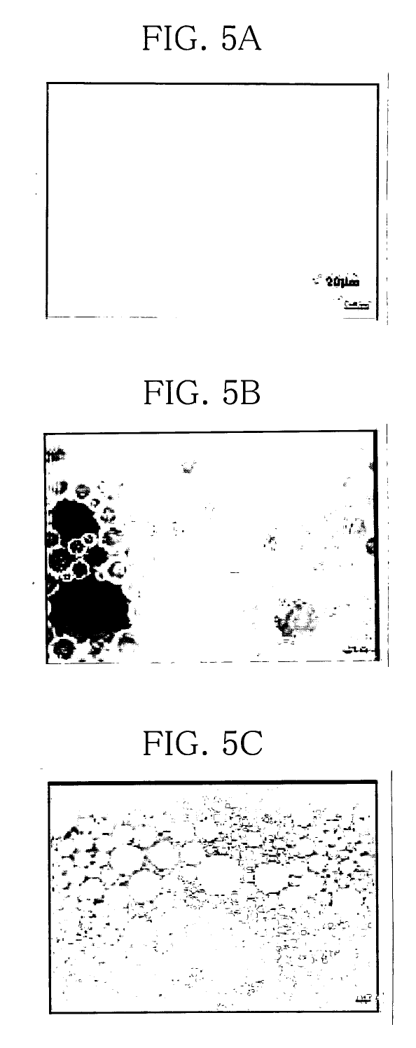

Specifically, salad oil and distilled water were supplied to YM-1 emulsator at flow rates of 3 cm³ per minute and 20 cm³ per minute, respectively, i.e., at an oil/water flow rate ratio (O/W) of 3/20, and mixed with each other in YM-1 to produce an emulsion. FIG. 5A is a microphotograph of the resultant emulsion. To produce another emulsion, oil and water were supplied to YM-1 emulsator at an O/W of 20/20, to be mixed therein. FIG. 5B is a microphotograph of the resultant emulsion. For comparison, oil and water were supplied at an O/W of 6/6 to a micromixer of IMM Mainz (hereinafter referred to as IMM or IMM mixer), thereby producing an emulsion. FIG. 5C is a microphotograph of the resultant emulsion.

According to observations in the experiments of emulsion production, when supplied with oil and water at an oil/water flow rate ratio of about 10%, both YM-1 emulsator and IMM mixer could produce an emulsion with small-sized particles stably dispersed therein. In a case where equal parts of oil and water were mixed, both YM-1 and IMM could produce a stable oil-rich emulsion. It was confirmed that YM-1 emulsator could produce a stable emulsion at a total flow rate equal to or larger than 12 cm³ per minute, but failed to produce an O/W emulsion at a low flow rate. The just-mentioned total flow rate value in YM-1, which is about ten times as large as that in IMM, indicates that YM-1 produces a considerably small pressure loss and has a superior emulsion production ability as compared to IMM. It is considered that this is because YM-1 has microchannels of a 400 μm width which is about ten times as wide as that of microchannels of IMM. In other words, the shearing rate in microchannels, which varies depending on the microchannel width, can be considered as being a primary factor that determines the pressure loss and emulsion production ability.

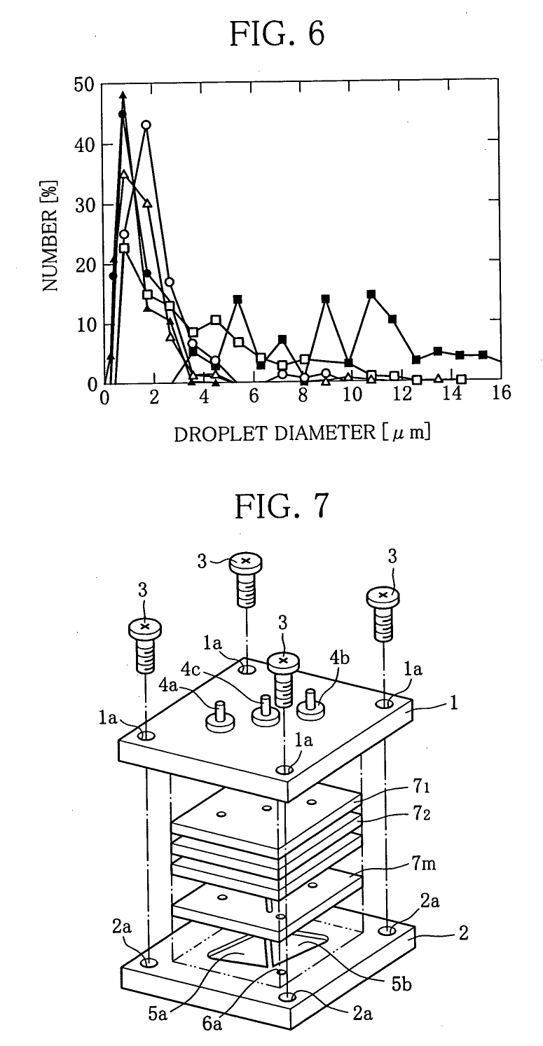

Droplet diameter distributions in the emulsions were also studied to thereby obtain results shown in FIG. 6 in which black circular marks, black triangular marks and black rectangular marks correspond to the emulsions produced by YM-1 at O/W=1/20, O/W=2/20 and O/W=20/20, respectively, whereas open circular marks, open triangular marks and open rectangular marks correspond to the emulsions produced by IMM at O/W=0.5/10, O/W=1/10 and O/W=4/4, respectively.

As shown by the black and open rectangular marks in FIG. 6, each of the oil-rich emulsions, obtained by mixing equal parts of oil and water by using YM-1 and IMM, has a broad distribution of droplet diameter varying from 1 μm to 15 μm. The emulsion produced by IMM has an average diameter of about 4 μm, whereas the average diameter of the emulsion obtained by YM-1 is about 7 μm. On the other hand, as for the oil-lean emulsions produced by YM-1 and IMM, the droplet diameter is within a range from about 1 μm to 3 μm. In other words, the droplet diameter distribution is narrow. The above indicates that YM-1 emulsator of this invention can be effectively utilized for the production of minute particles, etc. without using surface-active agent, in light of the above-mentioned excellent ability in emulsion production.

Next, with reference to FIG. 7, a concrete example of the micro emulsator having the above construction will be explained.

In FIG. 7, reference numerals 1 and 2 respectively denote upper and lower plate members of the micro emulsator. The pate members 1, 2 are each constituted by an Al or SUS plate which is rectangular as viewed in plan and which has one side length of about 50 mm and thickness of 5 mm, for instance. The plate members 1, 2 are formed at their four corners with through holes 1a and threaded holes 2a, respectively. By use of four bolts 3 extending through the through holes 1a of the upper plate member 1 and threadedly engaged with the threaded holes 2a of the lower plate member 2, the plate members and a plurality of, e.g., m, fluid passage modules 7₁-7ₘ (hereinafter indicated by reference numeral 7) are assembled into one piece, with the modules interposed between the plate members.

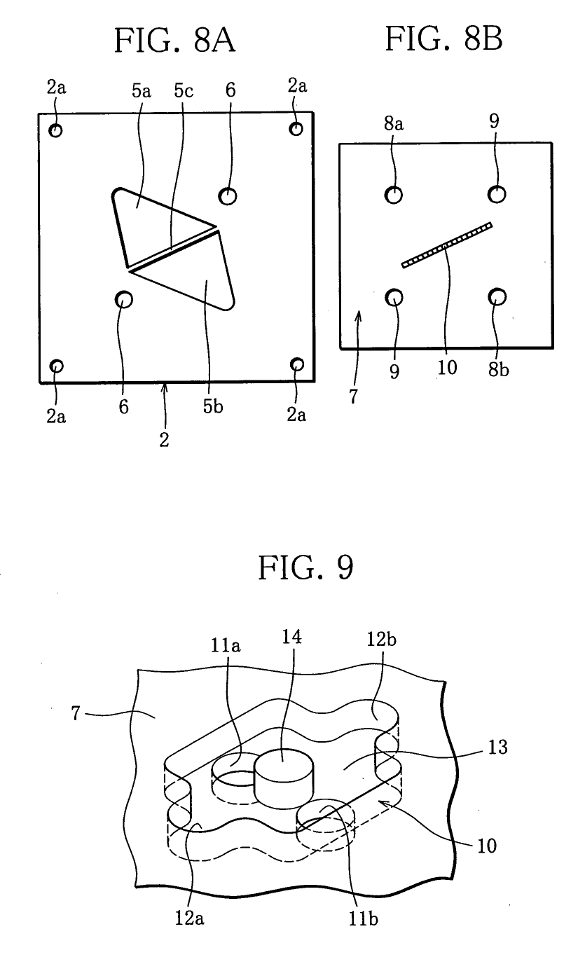

The upper plate member 1 is formed at its central part with three through holes (not shown) along one diagonal line of the plate member 1, and fluid inlet connectors 4a, 4b and a fluid outlet connector (i.e., emulsator outlet) 4c are connected to these three through holes, respectively. The lower plate member 2 is formed at its central part with triangular-shaped fluid inlet channels (i.e., emulsator inlets) 5a, 5b of a predetermined depth as shown in FIG. 8A, these inlet channels individually corresponding to the two through holes to which the fluid inlet connectors 4a, 4b are connected. The fluid inlet channels 5a, 5b are separated from each other by means of a partition wall 5a of a predetermined thickness. The lower plate member 2 is provided with pin holes 6 which receive guide pins (not shown) used for positioning the fluid passage modules 7 and for stacking them in layer.

The fluid passage modules 7 sandwiched between the plate members 1, 2 are each constituted by a rectangular Al plate which is about 0.8 mm in thickness and about 25 mm in one side length. As shown in FIG. 8B, each fluid passage module 7 is provided with through holes 8a, 8b respectively corresponding to the two through holes used for mounting the connectors 4a, 4b; through holes 9 through which the module-positioning guide pins extend; and one or more mixing/distributing units 10. In the fluid passage module 7 having a plurality of mixing/distributing units 10, these units 10 are arranged along the partition wall 5c as shown by way of example in FIG. 8B.

Each mixing/distributing unit 10 is provided, as exemplarily shown in FIG. 9, with two entries 11a, 11b respectively opening to an upstream-side (lower) face of the plate-like fluid passage module 7, two exits 12a, 12b respectively opening to a downstream-side (upper) face of the module 7, and a channel 13 that is formed in the upper face of the module 7. The entries 11a, 11b are in communication with the exits 12a, 12b through the channel 13, respectively. Thus, the channel 13 constitutes a fluid passage extending between the upper and lower faces of the fluid passage module 7.

In each mixing/distributing unit 10, an island-like separator 14 is provided at a central part of the channel 13, the entries 11a, 11b are provided symmetrically with respect to the separator 14 on the opposite sides thereof, and the exits 12a, 12b are also provided symmetrically with respect to the separator 14 on the opposite sides thereof. The array of the entries 11a, 11b extends perpendicularly to the array of the exits 12a, 12b. Each of the entries 11a, 11b and the exits 12a, 12b has a diameter of, e.g., 0.4 mm. The entries 11a, 11b are separated at a distance of 0.4 mm, whereas the exits 12a, 12b are separated at a distance of 1.2 mm. The channel 13 is 0.4 mm in width and depth. The width and depth (more generally, a representative length) of the channel, which determine the channel sectional area size, is preferably within a range from 100 μm to 500 μm. That is, the representative length of the channel is preferably made equal to or greater than 100 μm from the view point of preventing occurrences of pressure loss and channel clogging, and preferably made equal to or less than 500 μm from the view point of improving the emulsifying (mixing) efficiency.

As described above, each module 7 is provided with one or more mixing/distributing units 10 which become greater in number for the module 7 located at more upstream side. When the modules 7 are arranged in layer between the plate members 1, 2, each mixing/distributing units 10 provided in the individual module 7 is in communication with corresponding ones of immediately upstream and downstream mixing/distributing units 10. Thus, a large number of mixing/distributing units 10 in the modules 7 form, as a whole, a multi-layered fluid passage (multistage channel).

More specifically, one of the exits, the exit 12a, of each mixing/distributing unit 10 of the individual fluid passage module 7 is in communication with the entry 11a of a corresponding one mixing/distributing unit 10 in the immediately downstream fluid passage module 7, whereas another exit 12b is in communication with the entry 11b of another corresponding mixing/distributing unit 10 in the immediately downstream module 7. In other words, the two entries 11a, 11b of each unit 10 of the individual module 7 are brought into communication with the exit 12a of a corresponding one unit 10 and the exit 12b of another corresponding unit 10 in the immediately upstream module 7, respectively.

Thus, each mixing/distributing unit 10 of each individual fluid passage module 7 serves to receive, at its entries 11a and 11b, fluids individually discharged from the exit 12a of one unit 10 and the exit 12b of another unit 10 in the immediately upstream module 7, mix the fluids therein, and discharge the mixed fluid from its exits 12a, 12b to the inlet 11a of one unit 10 and the inlet 11b of another unit 10 in the immediately downstream module 7.

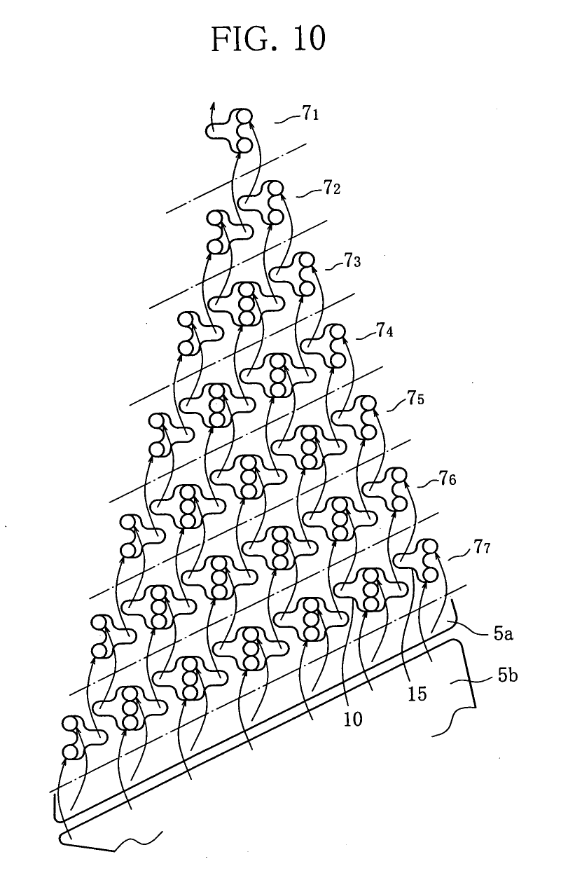

With reference to FIG. 10, the function of the mixing/distributing unit will be further described.

In the illustrated micro emulsator, seven fluid passage modules 7₁-7₇ are provided in layer between upper and lower plates. The downstream-most (uppermost) module 7₁ is provided with a single mixing unit 15, the module 7₂ is provided with two mixing units 15, and each of the modules 7₃-7₇ is provided with two outermost mixing units 15 and one or more mixing/distributing units 10 disposed therebetween. The number of units provided in each of the modules 7₁-7₇ becomes greater one by one for the module located at more upstream side, so that the upstream-most (lowermost) module 7₇ is provided with seven units in total.

The mixing unit 15 is obtained by removing one of the two exits 12a, 12b and part of the channel 13 communicating therewith from the mixing/distributing unit 10 shown in FIG. 9, and hence does not achieve the function of distributing a fluid mixed therein. Thus, the mixing unit 15 serves to receive fluids from its entries 11a, 11b, mix the fluids therein, and discharge the mixed fluid to a corresponding one mixing/distributing unit 10 or mixing unit 15 (to a corresponding unit 15 in the illustrated example) in the immediately downstream module 7₂, 7₃, . . . , or 7₇.

The one or more units 10 and/or 15 of each module 7 are so arranged that the exit 12a of one unit and the exit 12b of an adjacent unit in the module are respectively aligned with the entries 11a, 11b of a corresponding one unit 10 or 15 in the immediately downstream module.

In other words, one or more units 10 and/or 15 of each module 7 are so arranged that the exit 12a of one unit 10 or 15 and the exit 12b of another adjacent unit 10 or 15 in the module are respectively aligned with the entries 11a, 11b of a corresponding one unit 10 or 15 in the immediately downstream module 7.

As a consequence, by simply stacking the m modules 7, e.g., seven modules 7 in layer, the entries 11a, 11b of each unit 10 or 15 in the individual module 7 are brought into communication with the exits 12a, 12b of corresponding units in the adjacent module 7, so as to satisfy the just-mentioned relation.

According to the micro emulsator provided with the fluid passage modules 7 each comprised of one or more units 10 and/or 15 that are linearly arrayed at intervals of a predetermined distance, the total sectional area of one or more microchannels 13 in each individual module 7, i.e., the fluid passage sectional area of each individual channel stage, becomes smaller for the module located at more downstream side.

When two kinds of fluids (liquids) A, B are supplied at a predetermined pressure to the two fluid introducing channels 5a, 5b in the lower plate member 2, the fluid A is introduced into each of the units 10, 15 in the upstream-most module 7₇ via one entry 11a of that unit, whereas another fluid B is introduced into each unit via another entry 11b of the unit. These fluids A, B are mixed in the channel 13 of the unit 10 or 15, and the mixed fluid is distributed to and discharged from the exits 12a, 12b of this unit.

The next fluid passage module 7₆ receives, as a fluid A1 about to be mixed therein, the mixed fluid [A+B/2] discharged from the exit 12a of each unit 10 or 15 in the upstream-most module 7₇, at one entry 11a of a corresponding one unit 10 or 15 in the module 7₆, and receives, as another fluid B1 about to be mixed therein, the fluid [A+B/2] discharged from another exit 12b of each unit 10 or 15 in the module 7₇, at another entry 11b of the corresponding unit 10 or 15 in the module 7₆. The fluids A1, B1 are mixed in the channel 13 of each individual unit of the module 7₆, and the mixed fluid is distributed to and discharged from the two exits 12a, 12b of the unit.

The aforementioned fluid mixing and fluid distribution are repeated in the plural fluid passage modules 7, whereby subdivision (micro dispersion) of the two kinds of fluids A, B is promoted, and a micro-emulsified liquid (emulsion), i.e., a uniformly dispersed mixture of the liquids A, B, is taken out from the downstream-most module 7₁. To be noted, the mixing of the fluids A, B is effectively promoted, since the number of units and the effective fluid passage area become smaller for the module located at more outlet side.

According to the micro emulsator shown in FIGS. 7-10, therefore, a high-quality emulsion (mixture) of two kinds of fluids A, B with a uniform particle diameter can be efficiently mass-produced with a simple construction that is obtainable by simply stacking the plate-like fluid passage modules 7 in layer, each module having one or more units 10 and/or 15. The fluid passage modules 7 can be easily fabricated by using an Al or SUS plate, and the units 10, 15 can be also easily fabricated, resulting in low fabrication costs. Furthermore, the accuracy of alignment between the fluid passage modules 7 can be easily improved, e.g., by using guide pins, and these modules are easy to assemble, so that fabrication costs can be advantageously reduced also in this respect.

In the units 10, 15, diameters of the entries 11a, 11b and exits 12a, 12b are substantially the same from one another and substantially the same as the width of the channel 13, and accordingly these units are not easily clogged with a liquid mixture. In addition, the entries 11a, 11b are symmetric with respect to the center of the unit 10 or 15, the exits 12a, 12b are also symmetric with respect thereto, and the entry and exit arrays are perpendicular to each other. Thus, symmetrical fluid flow (laminar flow) is ensured, whereby fluid ununiformity can be effectively prevented, and emulsator throughput can be sufficiently increased. This improves the mixing performance (mixing efficiency) of the emulsator, thereby achieving a practical advantage that a high-quality, uniform emulsion (mixture) of different kinds of fluids can be easily mass-produced.

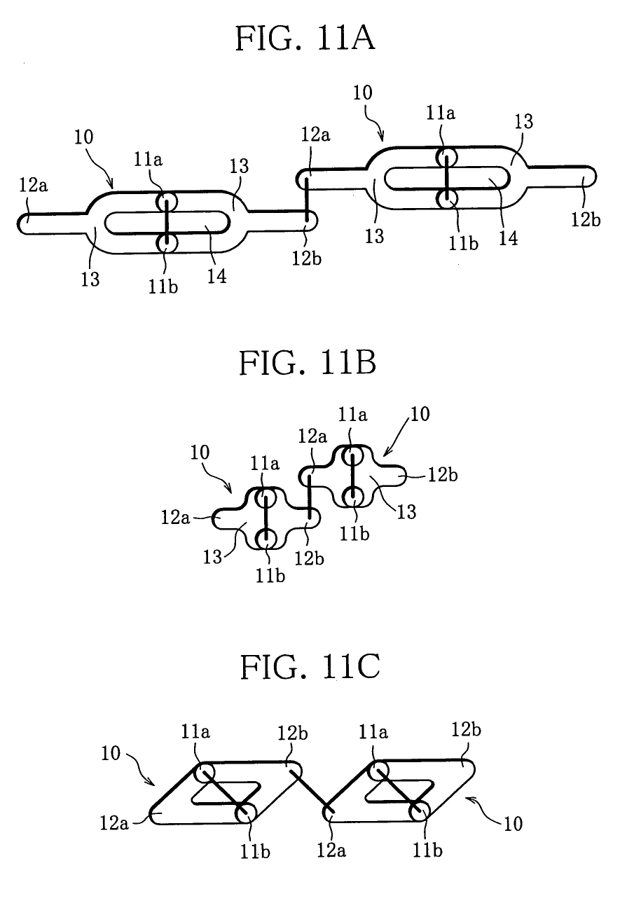

FIGS. 11A-11C show several modifications of the mixing/distributing unit 10 shown in FIG. 9.

In the unit 10 of FIG. 11A, the distance between the exits 12a, 12b is wider than that in the unit shown in FIG. 9. In the mixing/distributing unit 10 of FIG. 11B, the separator 14 of the unit of FIG. 9 is removed, and the distance between the exits 12a, 12b is made narrower. The mixing/distributing unit 10 of FIG. 11C comprises a parallelogram channel provided around the separator 14, and the entries 11a, 11b and the exits 12a, 12b are respectively disposed at four apexes of the parallelogram channel.

The mixing/distributing units 10 of FIGS. 11A-11C are so designed that the distance between the exits 12a, 12b of adjacent two units 10 in each individual fluid passage module is made equal to the distance between the entries 11a, 11b of a corresponding one unit 10 in an adjacent module, whereby corresponding ones of entries 11a, 11b and exits 12a, 12b of the modules 7 can be aligned accurately with one another.

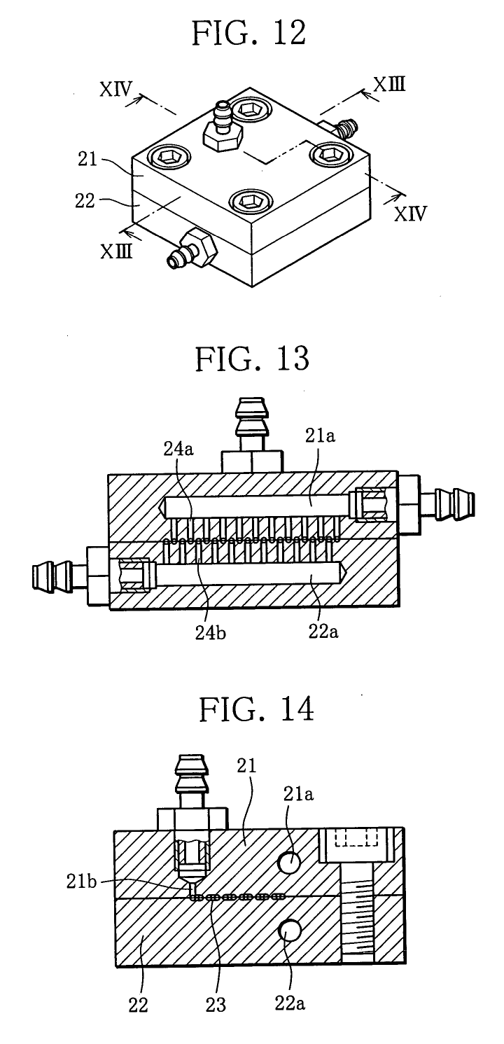

With reference to FIGS. 12-14, a simplified micro emulsator according to another embodiment of this invention will be described.

This simplified micro emulsator comprises two plates 21, 22 that are joined into one piece, and a multistage microchannel 23 of 100-500 μm in width is formed in a joining surface of these plates. The plate 21 is formed with a fluid introducing port 21a for introducing a fluid into the microchannel 23 and a fluid discharging port 21b for discharging an emulsion produced in the microchannel 23, whereas the plate 22 is formed with another fluid introducing port 22a.

The multistage microchannel 23 is formed by grooving in the joining surface of the plates 21, 22, and extends between inlets 24a, 24b and an outlet 25. The inlets 24a, 24b communicate with the fluid introducing ports 21a and 22a, respectively, and are disposed alternately with one another, whereas the outlet 25 communicates with the fluid discharging port 21b. The multistage microchannel 23 comprises a plurality of channel stages, and vertical channels of each individual channel stage decrease in number one by one from upstream channel stage on the side of inlets 24a, 24b toward downstream channel stage on the side of outlet 25. Also, the fluid passage sectional area of individual channel stage becomes smaller for the channel stage located at more downstream outlet 25 side. The vertical channels of individual channel stage communicate with vertical channels of the next channel stage through a lateral channel provided between these adjacent channel stages.

According to the micro emulsator having the multistage microchannel 23, therefore, fluids (oil and water) individually supplied via the inlets 24a, 24b are gradually mixed in the channel stages by means of a mixing/distributing function of the vertical and lateral channels provided in and between the channel stages. During the fluid mixing, flow velocities of fluids become gradually higher so that fluid mixing is efficiently made since the fluid passage sectional area of the multistage microchannel 23 gets narrower toward the outlet 25.

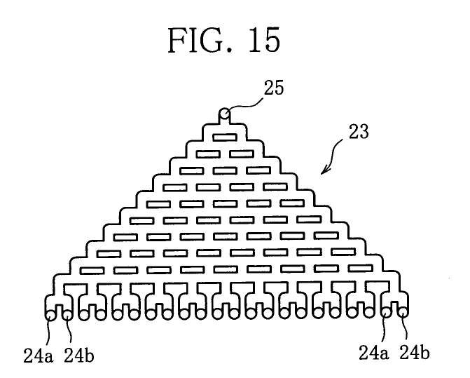

Thus, even by using the simplified micro emulsator shown in FIGS. 12-15, practically sufficient results can be attained in emulsion production. Since the simplified emulsator can be fabricated by simply grooving the multistage microchannel 23 in the plates 21, 22 and drilling the fluid introducing ports 21a, 22a and the like, this emulsator can be advantageously mass-produced at low costs.

The present invention is not limited to the foregoing embodiments, and may be modified variously.

For example, micro emulsators for mixing two kinds of fluids together have been explained in the embodiments, however, a micro emulsator can be constructed so as to mix three kinds of fluids or more.

What is claimed is:

1. An emulsifying method comprising the steps of:
(a) introducing plural kinds of fluids into a multistage channel; and
(b) mixing the fluids in the multistage channel to produce an emulsion,
wherein shear stress is caused to generate in the fluids during the fluid mixing in the multistage channel, thereby generating electric charges in the fluids due to the shear stress, while interfacial areas between the fluids are increased.

2. The emulsifying method according to claim 1, wherein said step (b) includes causing a degree of increase in interfacial areas between the fluids and a degree of electric charge generation to gradually increase from an upstream side toward a downstream side of the multistage channel.

3. The emulsifying method according to claim 1, wherein said step (b) includes dividing a fluid, joining fluids into one, converting a fluid flow, and making inertia-force-based mixing.

4. An emulsifying apparatus comprising:
plural inlets;
a single outlet; and
a multistage channel provided between said plural inlets and said single outlet, said multistage channel being comprised of a plurality of channel stages each constituted by one or more channels, said multistage channel having a fluid passage sectional area thereof gradually decreasing from an inlet side to an outlet side of said emulsifying apparatus.

5. The emulsifying apparatus according to claim 4, wherein said multistage channel includes an upstream-most channel stage comprised of plural channels individually connected to said inlets, a downstream-most channel stage comprised of a single channel connected to said outlet, and plural intermediate channel stages interposed between said upstream-most and downstream-most channel stages and each constituted by plural channels,
each channel of the individual channel stage is in communication with at least one corresponding channel of the immediately downstream channel stage,
the number of channels constituting each of the upstream-most and intermediate channel stages decreases as a position of the channel stage in the multistage channel gets closer to the outlet, and
the individual channel stage has a total channel sectional area that decreases as the position of the channel stage gets closer to the outlet.

6. The emulsifying apparatus according to claim 5, wherein the respective channels have substantially the same sectional area.

7. The emulsifying apparatus according to claim 5, wherein each of said intermediate channel stages other than one adjacent to said downstream-most channel stage includes two mixing channels, each having first and second entries and first exit, and one or more mixing/distributing channels disposed between said mixing channels and each having first and second entries and first and second exits,
said first and second entries of the individual mixing/distributing channel are in communication with said first exit of a corresponding one mixing/distributing channel of the immediately upstream channel stage and said second exit of another corresponding mixing/distributing channel of the immediately upstream channel stage, respectively, whereas said first and second exits of the individual mixing/distributing channel are in communication with said first entry of a corresponding one mixing/distributing channel or mixing channel of the immediately downstream channel stage and said second entry of another corresponding mixing/distributing channel or mixing channel of the immediately downstream channel stage, respectively.

8. The emulsifying apparatus according to claim 7, wherein said upstream-most channel stage includes two mixing channels and plural mixing/distributing channels disposed therebetween whose first and second entries are each connected to a corresponding one of said inlets, and
said downstream-most channel stage includes a mixing channel whose first exit is connected to said outlet.

9. The emulsifying apparatus according to claim 4, wherein said each channel stage is constituted by a channel having an entry and an exit and having a tapered cross section,
the entry of each individual channel is connected to said plural inlets or the exit of an immediately upstream channel, and the exit of each individual channel is connected to said outlet or the entry of an immediately downstream channel.

10. The emulsifying apparatus according to claim 4, wherein said multistage channel includes at least one division section for dividing a fluid, at least one confluence section for joining fluids into one, and at least one diversion section for diverting a fluid flow that are arranged in a predetermined order from the inlet side to the outlet side.

11. The emulsifying apparatus according to claim 4, wherein said multistage channel is comprised of one or more channels each having a representative length varying from 100 μm to 500 μm.

12. The emulsifying apparatus according to claim 4, wherein said multistage channel is comprised of a series of grooves formed in a joining surface of plates.

13. The emulsifying apparatus according to claim 4, further comprising:
upper and lower plate members; and
plural passage fluid modules provided in layer between said upper and lower plate members,
wherein each of said passage fluid modules includes one or more mixing units and/or one or more mixing/distributing units,
a total number of the one or more mixing units and the one or more mixing/distributing units in the individual fluid passage module is smaller than that of the units in the immediately upstream fluid passage module, and
each of the mixing units and/or the mixing/distributing units in the individual fluid passage module has two entries and at least one exit that is in communication with one of the entries of a corresponding one of the mixing units and/or the mixing/distributing units in the immediately downstream fluid passage module.

14. The emulsifying apparatus according to claim 13, wherein each of the mixing/distributing units has first and second entries, and has first and second exits that are in communication with the first entry of a corresponding mixing/distributing unit of the immediately downstream fluid passage module and the second entry of another corresponding mixing/distributing unit of the immediately downstream fluid passage module, respectively.

15. The emulsifying apparatus according to claim 4, wherein said multistage channel is formed by grooving in a joining surface of plates,
said multistage channel includes plural channel stages each having one or more first channels,
the number of the first channels of the individual channel stage is greater than that of the first channels of the immediately downstream channel stage, and
each of the first channels is in communication with the first channels of the immediately downstream channel stage through a second channel provided between the channel stage to which said each first channel belongs and the immediately downstream channel stage.
